(19) United States
(12) Patent Application Publication
(10) Pub. No.: US 2017/0200059 A1
(43) Pub. Date: Jul. 13, 2017

(54) CHECK IMAGE CORRECTION MACROS

(71) Applicant: Digital Check Corporation, Northbrook, IL (US)

(72) Inventors: Rian Maloney, Frisco, TX (US); Scott Weber, Arlington, TX (US)

(73) Assignee: Digital Check Corporation, Northbrook, IL (US)

(21) Appl. No.: 14/992,271

(22) Filed: Jan. 11, 2016

(51) Int. Cl. G06K 9/40; G06T 5/00; G06Q 20/04

(52) U.S. Cl. CPC G06K 9/40; G06Q 20/0425; G06T 5/002; G06T 5/009; G06T 2207/30176; G06T 2207/20208

(57) ABSTRACT

The present disclosure involves systems, software, and computer-implemented methods for applying correction macros to a clearing payment instrument image. An example method includes identifying a correction macro including one or more image processing actions to apply to a first clearing payment instrument image; associating the correction macro with a first attribute of the first clearing payment instrument image; and determining that the correction macro is to be applied to a second clearing payment instrument including a second attribute based on the second attribute matching the first attribute associated with the correction macro.

### BACKGROUND

The present disclosure relates to systems, software, and computer-implemented methods for applying correction macros to a clearing payment instrument image.

In check processing, physical payment instruments are scanned using image capture devices (e.g., scanners) to produce payment instrument images. These payment instrument images may be used in lieu of the original physical payment instruments when clearing transactions between financial institutions.

### SUMMARY

The present disclosure involves systems, software, and computer-implemented methods for applying correction macros to a clearing payment instrument image. In one general aspect, an example method includes identifying a correction macro including one or more image processing actions to apply to a first clearing payment instrument image; associating the correction macro with a first attribute of the first clearing payment instrument image; and determining that the correction macro is to be applied to a second clearing payment instrument including a second attribute based on the second attribute matching the first attribute associated with the correction macro.

In another general aspect, an example method includes receiving a first clearing payment instrument image; determining a first plurality of attributes present in the first clearing payment instrument image; identifying a correction macro applied to the first clearing payment instrument image; associating the correction macro with the first plurality of attributes; receiving a second clearing payment instrument image; determining a second plurality of attributes present in the second clearing payment instrument image; determining that at least one of the second plurality of attributes matches one in the first plurality of attributes; and in response to the determining, automatically applying the correction macro to the second clearing payment instrument image.

In another general aspect, an example method includes receiving a clearing payment instrument image with an attribute, wherein the attribute includes a black-to-white ratio of a black-and-white image created from the clearing payment instrument image; determining that the black-to-white ratio exceeds a darkness threshold; and in response to the determining, automatically applying an image processing action of raising a black threshold associated with the clearing payment instrument image.

In another general aspect, an example method includes receiving a clearing payment instrument image with an attribute, wherein the attribute includes a black-to-white ratio of a black-and-white image created from the clearing payment instrument image; determining that the black-to-white ratio is below a lightness threshold; and in response to the determining, automatically applying an image processing action of lowering a black threshold associated with the clearing payment instrument image.

While generally described as computer-implemented software embodied on non-transitory, tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for applying correction macros to a clearing payment instrument image.

FIG. 2 is a diagram illustrating an example user interface to an example correction macros creation tool.

FIG. 3 is a flow chart of an example process for applying correction macros to a clearing payment instrument image according to an implementation.

FIG. 4 is a block diagram of computing devices that may be used to implement the systems and methods described in this document, as either a client or as a server or plurality of servers according to an implementation.

Like reference numbers and designations in the various drawings indicate like elements.

### DETAILED DESCRIPTION

The present disclosure involves systems, software, and computer-implemented methods for applying correction macros to a clearing payment instrument image.

Generally, a bank receiving physical payment instruments for deposit scans the payment instruments to produce original payment instrument images corresponding to the physical payment instruments. Payment instruments, in general, are non-cash instruments for exchanging value from one party to another, such as, for example, checks, cashier's checks, deposit slips, traveler's checks, or other instruments. These images are processed to produce payment instrument images suitable for use in the clearing process (clearing payment instrument images), which are then submitted to an appropriate financial institution for clearing. In some cases, the original payment instrument images may be monochromatic images (e.g., grayscale), color images, or other types of images, while the clearing payment instrument images may be monochromatic images, bi-tonal (e.g., black and white) images, reduced color images, or other types of images.

In some cases, a clearing payment instrument image may not capture all the necessary information on the check. For example, if the check includes a background or watermark image with multiple light and dark regions, the produced clearing image may include regions of low contrast, making it unsuitable for electronic processing. A user/system may apply some image processing actions to the clearing image to improve its quality (e.g., readability) for electronic processing, such as, for example, adjusting conversion threshold, removing isolated speckling, removing dithering patterns, removing repetitious diagonal line patterns, and other image processing actions.

The present disclosure describes techniques for applying correction macros to a clearing payment instrument image such that clearing payment instrument images having matching attributes (e.g., account number, routing number) may undergo the same image processing actions. One example method includes storing the image processing actions performed on a first clearing payment instrument image to a correction macro. The correction macro is then associated with a first attribute of the first clearing payment instrument image. A second clearing payment instrument image is received for processing. The correction macro is automatically applied to the second clearing payment instrument image having a second attribute that matches the first attribute associated with the stored actions. In some cases, correction macros may be received by a user interface. In some cases, clearing payment instrument images may be received along with their corresponding attributes by the user interface.

Implementations according to the present disclosure may provide the following advantages over prior techniques. Storing and reusing correction macros may enable image processing of clearing payment instrument images with limited user intervention. Because clearing payment instrument images having the same attributes (e.g., account number, routing number) may use the same correction macros, storing and reusing correction macros may free the user from performing repeated sequence of image processing actions to the clearing payment instrument images.

These features and additional features are described in more detail below.

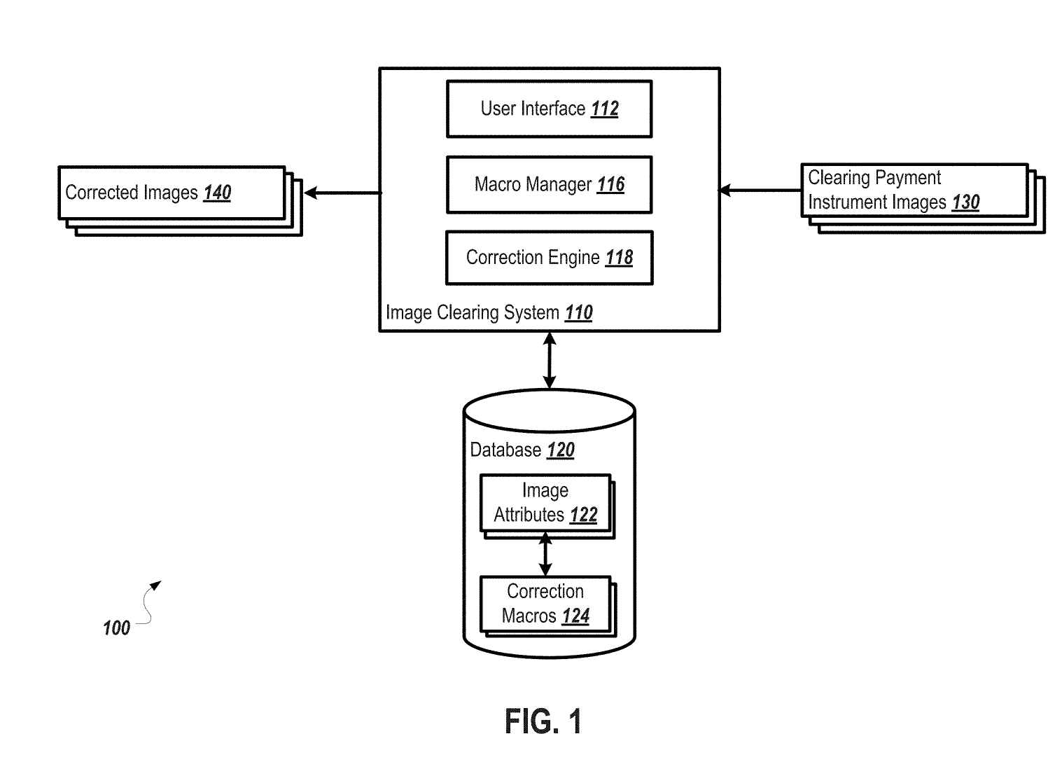

FIG. 1 is a block diagram of an example system 100 for applying correction macros to a clearing payment instrument image. At a high level, system 100 includes an image clearing system 110, a database 120, and one or more clearing payment instrument images 130. In operation, the image clearing system 110 receives one or more clearing payment instrument images 130. The image clearing system 110 identifies attributes (e.g., account number, routing number) of each clearing payment instrument image 130. The image clearing system 110 searches the database 120 to determine whether a correction macro associated with the attributes of each clearing payment instrument image 130 is stored in the database 120. If it is determined that an associated correction macro is stored in the database 120, the image clearing system 110 automatically applies the associated correction macro to the clearing payment instrument image 130 to produce a corresponding correct image 140. In some implementations, if it is determined that an associated correction macro is not stored in the database 120, the image clearing system 110 may provide a user with options to define one or more image processing actions to apply to the clearing payment instrument image 130. In some implementations, the image clearing system 110 may store the user-defined one or more image processing actions to a correction macro in the database 120. In some other implementations, the user may store the defined one or more image processing actions to a correction macro in the database 120.

The one or more clearing payment instrument images 130 can be communicated to the image clearing system 110 (e.g., by a push- or pull-type data transfer operation) for applying correction macros to them. In some implementations, the one or more clearing payment instrument images 130 may be monochromatic images (e.g., grayscale), bi-tonal (e.g., black and white) images, reduced color images, or other types of images. As illustrated, the image clearing system 110 is communicably coupled to the database 120 which stores image attributes 122 and associated correction macros 124 for use in correcting the one or more clearing payment instrument images 130 by the image clearing system 110.

The image clearing system 110 may be a computing device or set of computing devices operable to receive clearing payment instrument images and apply correction macros to the clearing payment instrument images. In some implementations, the image clearing system 110 may be a computing device executing one or more software programs to perform these actions. The image clearing system 110 may include an operating system for controlling its execution and operation, including, but not limited to, MICROSOFT WINDOWS, LINUX, APPLE OS X, APPLE IOS, ANDROID, UNIX, BSD, or other operating systems. The image clearing system 110 may also include other standard computing components, such as, for example, one or more memories, one or more input devices such as keyboards, mice, touch screens, or other devices, one or more output devices such as displays, speakers, or other devices, or other computing components.

As shown, the image clearing system 110 includes a user interface 112 for communicating with a user. In some implementations, the user interface 112 allows the user to input one or more clearing payment instrument images 130 to the image clearing system 110 for processing. In some cases, the user interface 112 allows the user to perform a sequence of image processing actions to a specific clearing payment instrument image and store the sequence of image processing actions to a correction macro (e.g., 124) associated with attributes of the specific clearing payment instrument image (e.g., 122). In some cases, the user can input additional attributes of the one or more clearing payment instrument images 130 through the user interface 112. The user can also input correction macros to be stored and reused by the image clearing system 110 through the user interface 112.

The user interface 112 includes logic encoded in software and/or hardware. More specifically, the user interface 112 may comprise software supporting one or more communication protocols allowing information to be exchanged between the image clearing system 110 and the user. The user interface 112 may also be operable to present a visual interface to the user, and to receive input in response to the user interacting with the visual interface. In some cases, the visual interface may include one or more web pages provided to the user over a network. The user interface 112 may also interact with a client application executing on the user's computing device to receive input.

The image clearing system 110 includes a macro manager 116. In some implementations, the macro manager 116 is a software application operable to identify attributes of a particular clearing payment instrument image 130, and identify a correction macro 124 from the database 120 that is associated with the attributes (e.g., 122). In one example, the macro manager 116 identifies a particular clearing payment instrument image 130 as having a routing number of “12345001” and an account number of “6874569989.” The macro manager 116 can query the database to determine if these attributes are associated with a correction macro 124. If the macro manager 116 finds an associated correction macro 124, it can instruct the correction engine 118 to implement the corrections described by the macro 124 on the particular clearing payment instrument image 130, as described below.

The image clearing system 110 includes a correction engine 118. In some implementations, the correction engine 118 is a software application operable to apply a correction macro to the clearing payment instrument images 130. For example, the correction engine 118 can be instructed by the macro manager 116 to apply a particular correction macro 124 to the particular clearing payment instrument image 130. The correction macro 124 may include a sequence of instructions identifying operations to be performed on the particular clearing payment instrument image 130. The operation may be image manipulation operations, such as, for example, converting the image to grayscale by computer algorithms such as filters which perform Gaussian actions, blurring actions, or other actions, converting the grayscale image back to a black and white image, raising a black threshold of the grayscale image, lowering a black threshold of the grayscale image, de-speckling the image, sharpening the image, removing noise from the image, or other operations. The instructions may include parameters for the operations to be performed (e.g., “raise black threshold to 65”). In some cases, the instructions may be written in a particular programming language, such as, for example, JAVASCRIPT, JAVA, C#, PYTHON, PERL, or a proprietary language.

As illustrated, the image clearing system 110 is communicably coupled to the database 120. In some implementations, the database 120 may be a storage device or set of storage devices integrated within the image clearing system 110, such as, for example, a hard drive, Random Access Memory (RAM), flash memory, or other storage devices or combinations of storage devices. The database 120 may also be an external storage device accessed by the image clearing system 110 over a communications network, such as, for example, Fiber Channel, Ethernet, USB, IEEE 1394, or other network.

The database 120 includes image attributes 122 and correction macros 124. Image attributes 122 typically include image attributes that have been identified by the image clearing system 110. Correction macros 124 typically include user-defined or stored correction macros that can be applied to a clearing payment instrument image to improve its image quality. Each correction macro stored in the correction macros 124 can be associated with one or more specific attribute in image attributes 122.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, JAVA, C#, assembler, PERL, PYTHON, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

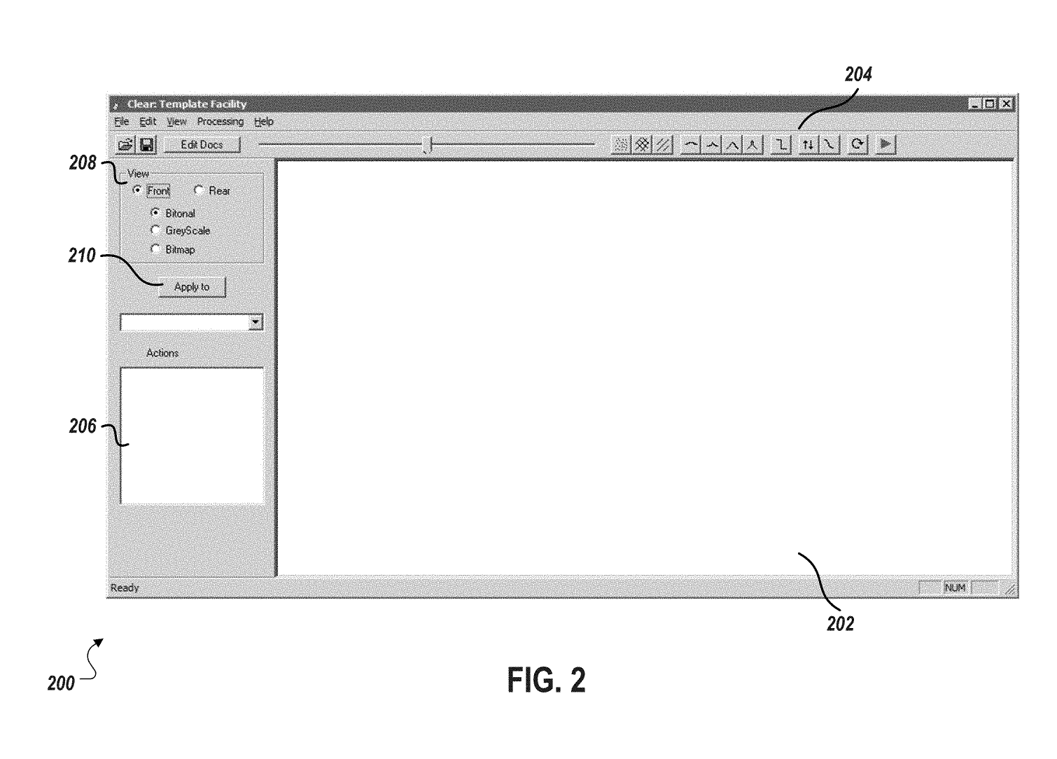

FIG. 2 is a diagram illustrating an example user interface 200 to an example correction macros creation tool. The user interface 200 includes a display pane 202, a button pane 204, an actions pane 206, an option pane 208, and a pane 210. In this example user interface 200, a clearing payment instrument image is displayed in the display pane 204 where a user can apply one or more correction macros selected from the button pane 204. When the selected one or more correction macros are applied to the clearing payment instrument image, names of the one or more correction macros are recorded in the actions pane 206. The option pane 208 provides the user with options to apply the selected one or more correction macros to a front or rear side of the clearing payment instrument image. The option pane 208 also provides the user with options to apply the selected one or more correction macros to a bi-tonal, grayscale, or bitmap image of the clearing payment instrument image. In some cases, groups of correction macros are selected to apply to a specific clearing payment instrument image using the pane 210. In some cases, correction macros can be replayed to test the correct application to other clearing payment instrument images using the button pane 204. In some other cases, correction macros are saved for use by the macro manager 116 using the option menu or the button pane 204 of the user interface 200.

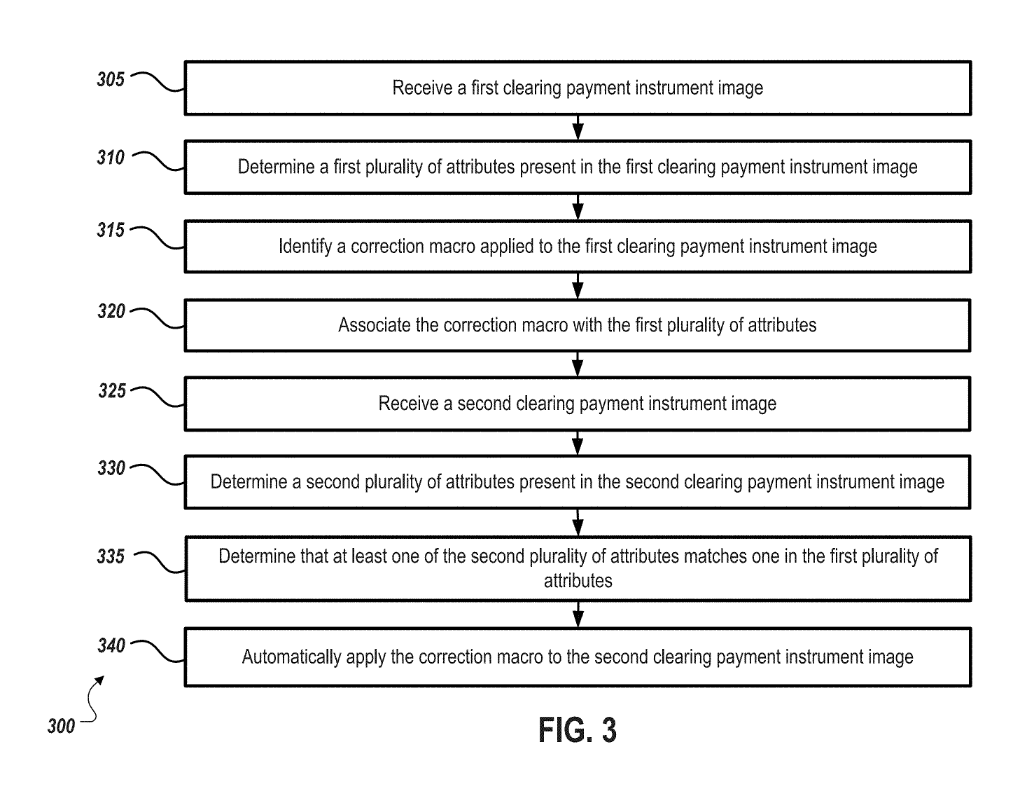

FIG. 3 is a flow chart of an example process for applying correction macros to a clearing payment instrument image according to an implementation. For clarity of presentation, the description that follows generally describes method 300 in the context of FIGS. 1-2 and 4. However, method 300 may be performed, for example, by any other suitable system, environment, software, and hardware, or a combination of systems, environments, software, and hardware, as appropriate.

At 305, a first clearing payment instrument image is received. In some implementations, the first clearing payment instrument image may be a monochromatic image (e.g., grayscale), a bi-tonal (e.g., black and white) image, a reduced color image, or other types of image. In some implementations, attributes of the first clearing payment instrument image are also received.

At 310, a first plurality of attributes present in the first clearing payment instrument image is determined. The first plurality of attributes may be determined from data extracted from the first clearing payment instrument image, attributes received at 305, or both. In some implementations, the first plurality of artifacts includes an account number or a routing number. In some implementations, when the first clearing payment instrument image is a black-and-white image, the first plurality of artifacts includes a black-to-white ratio of the first clearing payment instrument image. In some other implementations, when the first clearing payment instrument image is not a black-and-white image, a black-and-white image is created from the first clearing payment instrument image and a black-to-white ratio of the created black-and-white image is determined to be included in the first plurality of artifacts.

At 315, a correction macro applied to the first clearing payment instrument image is identified. The correction macro may include one or more image processing actions, such as, for example, adjusting conversion threshold, removing isolated speckling, removing dithering patterns, removing repetitious diagonal line patterns, and other image processing actions. In some implementations, the correction macro is retrieved from a database. In some other implementations, the correction macro is identified by user operations performed on the first clearing payment instrument image. In some cases, when the first clearing payment instrument image is a black-and-white image, the correction macro may include converting the black-and-white payment instrument image into a grayscale payment instrument image by computer algorithms such as filters which perform Gaussian actions, blurring actions, or other actions., adjusting the grayscale payment instrument image, and converting the adjusted grayscale payment instrument image back into a second black-and-white payment instrument image.

At 320, the correction macro is associated with the first plurality of attributes. In some implementations, when the first plurality of attributes includes a black-to-white ratio of a black-and-white image created from the first clearing payment instrument image, associating the correction macro with the first plurality of attributes is performed based on the black-to-white ratio exceeding a darkness threshold, and the correction macro includes an image processing action of raising a black threshold associated with the first clearing payment instrument image. In some implementations, associating the correction macro with the first plurality of attributes is performed based on the black-to-white ratio being below a lightness threshold, and the correction macro includes an image processing action of lowering a black threshold associated with the first clearing payment instrument image. In some cases, the correction macro is associated with each attribute in the first plurality of attributes. In some other cases, the correction macro is associated with a fraction of the first plurality of attributes. In some implementations, the association may be stored in a database.

At 325, a second clearing payment instrument image is received. In some implementations, the second clearing payment instrument image may be a monochromatic image (e.g., grayscale), a bi-tonal (e.g., black and white) image, a reduced color image, or other types of image. In some implementations, attributes of the second clearing payment instrument image are also received. From 325, process 300 proceeds to 330.

At 330, a second plurality of attributes present in the second clearing payment instrument image is determined. The second plurality of attributes may be determined from data extracted from the second clearing payment instrument image, attributes received at 325, or both. In some implementations, the second plurality of artifacts includes an account number or a routing number. In some implementations, when the second clearing payment instrument image is a black-and-white image, the second plurality of artifacts includes a black-to-white ratio of the second clearing payment instrument image. In some other implementations, when the second clearing payment instrument image is not a black-and-white image, a black-and-white image is created from the second clearing payment instrument image and a black-to-white ratio of the created black-and-white image is determined to be included in the second plurality of artifacts.

At 335, at least one of the second plurality of attributes of the second clearing payment instrument image is determined to match one attribute in the first plurality of attributes of the first clearing payment instrument image. In some implementations, the determination is made based on the same account number, the same routing number, or both.

At 340, in response to the determination, the correction macro associated with the first plurality of attributes is automatically applied to the second clearing payment instrument image. Additional process actions (not shown in FIG. 3) may be added to improve the effectiveness of the stored correction macros. In some instances, after 340, the processed second clearing payment instrument image may be presented for user review. If the user makes additional adjustment over the processed second clearing payment instrument image, the additional image processing actions taken by the user may be included and stored in the identified correction macro. In this way, the user can update the correction macros dynamically for new problems identified in a specific family of clearing payment instrument images.

The preceding figures and accompanying description illustrate example processes and computer-implementable techniques. System 100 (or its software or other components) contemplates using, implementing, or executing any suitable technique for performing these and other tasks. These processes are for illustration purposes only, and the described or similar techniques may be performed at any appropriate time, including concurrently, individually, or in combination. In addition, many of the steps in these processes may take place simultaneously, concurrently, and/or in different order than as shown. Moreover, system 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

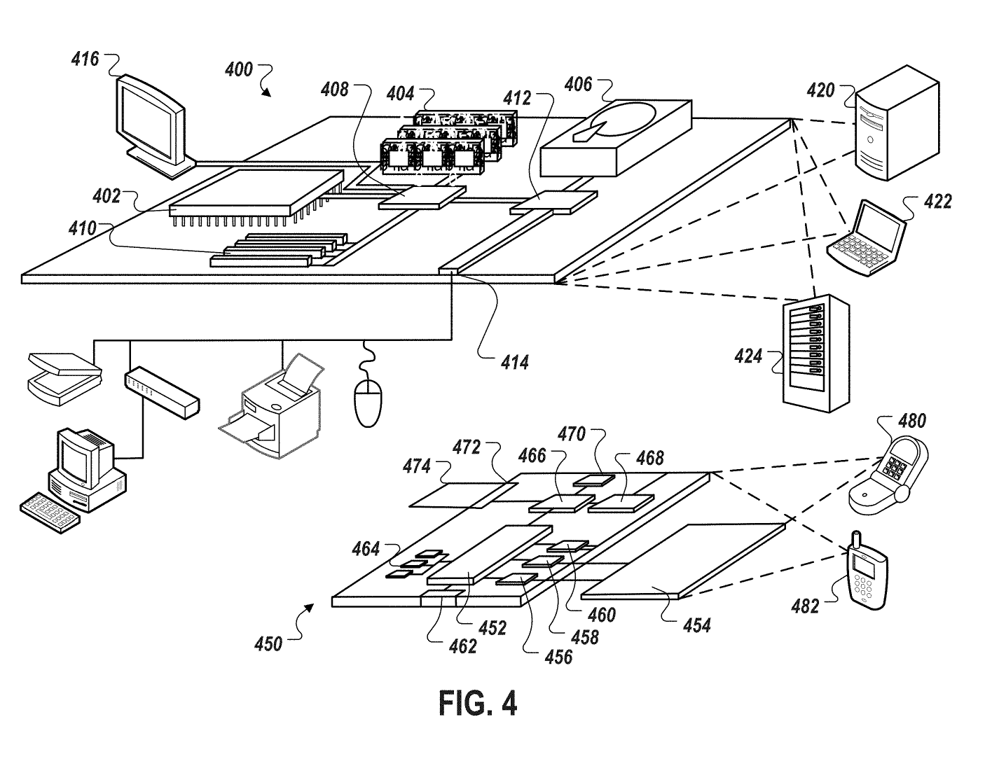

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. Additionally computing device 400 or 450 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed expansion port 414 and storage device 406. Each of the components 402, 404, 406, 408, 410, and 412 are interconnected using various busses and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of functions is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468 are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. Additionally, the processor may be implemented using any of a number of architectures. For example, the processor 452 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above and may also include secure information. Thus, for example, expansion memory 474 may be provided as a security module for device 450 and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452 that may be received, for example, over transceiver 468 or external interface 462.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 470 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.), and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method executed by one or more processors, the method comprising:
identifying a correction macro including one or more image processing actions to apply to a first clearing payment instrument image;
associating the correction macro with a first attribute of the first clearing payment instrument image; and
determining that the correction macro is to be applied to a second clearing payment instrument including a second attribute based on the second attribute matching the first attribute associated with the correction macro.

2. The method of claim 1, wherein the second clearing payment instrument image is a black-and-white payment instrument image.

3. The method of claim 2, wherein the one or more image processing actions include:
converting the black-and-white payment instrument image into a grayscale payment instrument image by computer algorithms, the computer algorithms including filters, and the filters performing actions including Gaussian actions or blurring actions;
adjusting the grayscale payment instrument image; and
converting the adjusted grayscale payment instrument image into a second black-and-white payment instrument image.

4. The method of claim 1, wherein the one or more image processing actions include removing isolated speckling, removing dithering patterns, removing repetitious diagonal line patterns, or adjusting conversion threshold.

5. The method of claim 1, wherein the first attribute includes an account number or a routing number.

6. The method of claim 1, wherein the first attribute includes a black-to-white ratio of a black-and-white image created from the first clearing payment instrument image.

7. The method of claim 6, wherein associating the correction macro with the first attribute is performed based on the black-to-white ratio exceeding a darkness threshold, and the correction macro includes an image processing action of raising a black threshold associated with the first clearing payment instrument image.

8. The method of claim 6, wherein associating the correction macro with the first attribute is performed based on the black-to-white ratio being below a lightness threshold, and the correction macro includes an image processing action of lowering a black threshold associated with the first clearing payment instrument image.

9. A non-transitory, computer-readable medium storing instructions operable when executed to cause at least one processor to perform operations comprising:
identifying a correction macro including one or more image processing actions to apply to a first clearing payment instrument image;
associating the correction macro with a first attribute of the first clearing payment instrument image; and
determining that the correction macro is to be applied to a second clearing payment instrument including a second attribute based on the second attribute matching the first attribute associated with the correction macro.

10. The medium of claim 9, wherein the second clearing payment instrument image is a black-and-white payment instrument image.

11. The medium of claim 10, wherein the one or more image processing actions include:
converting the black-and-white payment instrument image into a grayscale payment instrument image by computer algorithms, the computer algorithms including filters, and the filters performing actions including Gaussian actions or blurring actions;
adjusting the grayscale payment instrument image; and
converting the adjusted grayscale payment instrument image into a second black-and-white payment instrument image.

12. The medium of claim 9, wherein the one or more image processing actions include removing isolated speckling, removing dithering patterns, removing repetitious diagonal line patterns, or adjusting conversion threshold.

13. The medium of claim 9, wherein the first attribute includes an account number or a routing number.

14. The medium of claim 9, wherein the first attribute includes a black-to-white ratio of a black-and-white image created from the first clearing payment instrument image.

15. The medium of claim 14, wherein associating the correction macro with the first attribute is performed based on the black-to-white ratio exceeding a darkness threshold, and the correction macro includes an image processing action of raising a black threshold associated with the first clearing payment instrument image.

16. The medium of claim 14, wherein associating the correction macro with the first attribute is performed based on the black-to-white ratio being below a lightness threshold, and the correction macro includes an image processing action of lowering a black threshold associated with the first clearing payment instrument image.

17. A system comprising:
memory for storing data; and
one or more processors operable to perform operations comprising:
identifying a correction macro including one or more image processing actions to apply to a first clearing payment instrument image;
associating the correction macro with a first attribute of the first clearing payment instrument image; and
determining that the correction macro is to be applied to a second clearing payment instrument including a second attribute based on the second attribute matching the first attribute associated with the correction macro.

18. The system of claim 17, wherein the second clearing payment instrument image is a black-and-white payment instrument image.

19. The system of claim 18, wherein the one or more image processing actions include:
converting the black-and-white payment instrument image into a grayscale payment instrument image by computer algorithms, the computer algorithms including filters, and the filters performing actions including Gaussian actions or blurring actions;
adjusting the grayscale payment instrument image; and
converting the adjusted grayscale payment instrument image into a second black-and-white payment instrument image.

20. The system of claim 17, wherein the one or more image processing actions include removing isolated speckling, removing dithering patterns, removing repetitious diagonal line patterns, or adjusting conversion threshold.
